(19) United States
(12) Patent Application Publication
(10) Pub. No.: US 2015/0293662 A1
(43) Pub. Date: Oct. 15, 2015

(54) METHOD FOR MANAGING THE ENTRY OF DATA BY PRESSING ON A TOUCH SURFACE OF AN ELECTRONIC TERMINAL, AND THE CORRESPONDING MODULE, TERMINAL, COMPUTER PROGRAM PRODUCT AND STORAGE MEDIUM

(71) Applicant: Compagnie Industrielle et Financiere D'Ingenierie "Ingenico", Paris (FR)

(72) Inventors: Sebastien James, Valence (FR); Pierre Pignal, Valence (FR); Sylvain Barneron, Bourg-Les-Valence (FR); David Naccache, Paris (FR)

(21) Appl. No.: 14/680,749

(22) Filed: Apr. 7, 2015

(30) Foreign Application Priority Data
Apr. 10, 2014 (FR) 1453195

(51) Int. Cl. G06F 3/0488; G06F 3/041

(52) U.S. Cl. CPC G06F 3/0488; G06F 3/0412

(57) ABSTRACT

A method is provided for managing the entry of data by pressing on a touch surface of an electronic terminal. The method includes: configuring a pressing validation time delay, delivering a variable pressing validation time delay according to at least one predetermined variation parameter and a rank of the pressing in a series of several pressings; and managing a plurality of pressings on the touch surface of the electronic terminal, taking account of the variable pressing validation time delay configured.

### CROSS-REFERENCE TO RELATED APPLICATION

This application claimed priority from French Application No, 1453195, filed Apr. 10, 2014 the content of which is incorporated herein by reference in its entirety.

### FIELD OF THE DISCLOSURE

The present disclosure relates to the field of electronic terminals having a touch screen for displaying data (such as a virtual keypad for example) and the entry of data (such as a confidential code via a virtual keypad for example) or the field of touch keypads (for example a capacitive keypad).

The disclosure applies more particularly to such terminals able to perform payment operations, referred to as payment terminals.

More precisely, the disclosure concerns the improvement of such electronic terminals with a view to use thereof by a user having visual deficiency, for example a partially sighted or non-sighted user (hereinafter referred to as a partially sighted user), or the adaptation of such electronic terminals according to the use thereof.

### Solutions of the Prior Art

At the present time more and more terminals are known comprising a touch screen, such as mobile telephones, personal digital assistants (referred to as PDAs), portable computers, commercial cash registers, etc.

There also exist electronic payment terminals comprising a touch screen. In this case, such a touch screen represents for example a virtual keypad for validating a confidential code, or the amount of a transaction.

One drawback of these electronic terminals lies however in the fact that they cannot be used by a partially sighted user.

This is because, unlike electronic terminals comprising a screen and a keypad on which the keys are in relief and where some have a touch marking on the surface (in particular the digit 5, and the validation, correction or cancellation keys for an electronic payment terminal keypad), each key of a virtual keypad of a conventional electronic terminal comprising a touch screen can be detected only visually, the front face of such an electronic payment terminal being perfectly smooth.

Confronted with this problem, some manufacturers have developed solutions consisting of applying a relief to the window (situated above the virtual keypad) forming the front face of the electronic terminal, the relief consisting for example of representing the 5 key, conventionally situated at the middle of a keypad, by a projecting or hollow point.

Thus, when a partially sighted user must enter, on such an electronic terminal, a confidential code to validate a transaction for example, he seeks this relief element, “groping” (that is to say by moving a finger over the touch surface of the terminal) in order to identify the 5 key and then to be able, still by moving his finger around this key, to enter the digits making up his confidential code.

One drawback of these solutions lies in the fact that since the 5 key is sought by moving on the touch screen, pressing on this key (or another) is frequently detected because of the presence of the finger of the user on the screen, then giving rise to an error in the entry of the confidential code when the 5 digit (or another wrongly validated digit) does not actually correspond to the first digit of this confidential code.

An improvement to these solutions has been proposed, consisting of adding a time delay for the detection of key pressings, thus limiting the number of “false” entries due to the search for the 5 key in relief. Thus it is necessary for the user to leave his finger at the same point on the touch screen for a certain length of time for a key pressing to be detected and validated.

On the other hand, the main drawback of this solution lies in the slowness of use of a such a keypad, which requires longer key pressings for them to be taken into consideration, making the entry of a confidential code appreciably less ergonomic, in particular for a user who is not partially sighted, who a priori does not need such a time delay for validating pressing.

There therefore exists a need for novel terminals comprising a touch screen enabling any user to use them, including partially sighted users, without sighted users being penalised in terms of ergonomics.

There also exists a need for an optimum solution in terms of cost, in a competitive environment where the cost of a terminal is an essential factor for manufacturers.

### SUMMARY

An aspect of the present disclosure relates to a method for managing the entry of data by pressing on a touch surface of an electronic terminal, the method using at least one time delay aimed at validating a pressing only if the duration of this pressing exceeds a predetermined threshold, referred to as the pressing validation time delay.

According to an exemplary embodiment, the method comprises the following steps:
a step of configuring the pressing validation time delay, delivering a variable pressing validation time delay according to at least one predetermined variation parameter and the rank of the pressing in a series of several pressings;
a step of managing a plurality of pressings on the touch surface of the electronic terminal, taking account of the variable pressing validation time delay configured.

Thus an aspect of the disclosure is based on a novel and inventive approach to the management of the entry of data by pressing on a touch surface, in particular optimising such entry in the case of a partially sighted user while not penalising entry for a user who is not partially sighted, unlike the solutions of the prior art.

To do this, the method according to one or more various embodiments of the disclosure makes provision for variably configuring a time delay for validating a key pressing, thus taking account of the specificities of entry of a partially sighted user and offering a user optimised ergonomics in the use of his terminal.

It should be stated here that a time delay for the validation of a pressing makes it possible to determine after how much time pressing on the touch screen is actually considered to be a key pressing, that is to say an actual entry of a data item by the user.

Thus, according to the predetermined variation criterion used for configuring the variability of the time delay, the method makes it possible to adapt the length of the time delay for each pressing on the touch screen, or according to the type of pressing (the rank of a pressing in a series of pressings, location of the pressing on the screen, etc.). Once this variability in the time delay has been configured, the pressings made by a user on the touch screen are managed by taking into account these various lengths of time delay in order to effect the appropriate processing of the data entered via these pressings.

According to a particular aspect of the disclosure, the predetermined variation parameter belongs to the group comprising:
a pressing validation time delay that is longer for the first pressing in a series of several pressings;
a pressing validation timed delay that is longer according to the location of the pressing on a region of the touch screen.

Thus, according to a first embodiment, the time delay variation parameter may reflect specific usage of the virtual keypad for a partially sighted user, needing to locate, by moving his finger on the touch screen, a particular key (the digit 5 for example, in the case where a point in relief represents this key) without a pressing on this key (or on another key over which the user passes his finger) being validated as an entry of the corresponding digit.

According to this example particularly suited to the entry of a confidential code on an electronic payment terminal by a partially sighted user, it is considered that the time delay for validating the first pressing in a series of several pressings is longer than the time delay for the following pressings. Because of this, the time spent by the user in locating the 5 key will not be taken into account as an actual entry of the digit 5, if it does not exceed the time delay configured for the first pressing.

To do this, the user must be informed of this variability in time delay according to the pressings, so as to leave his finger intentionally longer on the first digit of his confidential code, so as to validate its entry.

The time delay for the first pressing in a series may for example be fixed at 1 second, or the time delay for the following pressings may be fixed at 0.4 seconds, a conventional period optimum from an ergonomic point of view for a user. Thus, once the first digit of the confidential code has been entered, the following pressings may be briefer. This first embodiment thus allows optimum use of a virtual keyboard both for a partially sighted user and for a user who is not partially sighted, the extension of the pressing validation time delay for the first pressing not slowing down the global entry of a confidential code for example.

According to a second particular embodiment, which can be combined with the first embodiment described above, the time delay variation parameter makes it possible to manage, in a particular manner, keys situated in predetermined regions of the screen, such as the function keys for example, and more particularly the correction or cancellation keys.

Thus a longer time delay for the function key such as the cancellation or correction key on a virtual keyboard makes it possible to avoid false detections of these keys, by obliging the user to intentionally leave his finger longer on a screen when he wishes to correct or cancel an entry. For example, this variant prevents a user from entering his code once again when he has unfortunately pressed on the cancellation key instead of the validation key.

In particular, the step of configuring the pressing validation time delay is triggered by a selection of a predetermined entry mode, referred to as the variable time delay entry mode, for the electronic terminal.

Thus, according to this particular embodiment of the disclosure, the configuration of the variable time delay is triggered by the selection of a specific operating mode on the electronic terminal, referred to as the variable time delay entry mode.

This is because, in a so-called “normal”, or “conventional” functioning, the time delay for validating a pressing is fixed at a predetermined value, for example 0.4 seconds, whatever the pressing, that is to say whatever the rank of the pressing in a series of several pressings, or whatever the region of the pressing on the screen, etc.

Thus a terminal equipped with a method for managing the entry of data according to an embodiment of the disclosure makes it possible to adapt to the user, whether he be partially sighted or not, by offering optimum ergonomics for the two types of user.

This is because, selecting the variable time delay entry mode enables a partially sighted user to have optimum use of the terminal, in particular for entering his confidential code, whereas the conventional operating mode makes it possible not to “penalise” a user who is not partially sighted by fixing a short time delay for variation of a pressing and therefore not slowing down the entry of a confidential code for example, unlike the solutions of the prior art.

For example, the selection of a variable time delay entry mode belongs to the following group:
manual selection by at least one user of the electronic terminal, automatic selection by a reading, by said electronic terminal, of at least one predetermined item of information relating to at least one user of said electronic terminal.

According to a first variant embodiment, the variable time delay entry mode can be selected manually, by a user of the electronic terminal.

Thus, according to a first example, if the terminal is an electronic payment terminal of a shopkeeper, and the user identifies himself to the shopkeeper as being partially sighted, the shopkeeper may manually select the variable time delay entry mode according to the first variation criterion described above (longer time delay for the first pressing than the following pressings in a series). Once the variable time delay entry mode has been selected, the step of configuring the time delay is implemented and the variability of the time delay is made effective, according to the predetermined variation criterion chosen.

According to another example of the first variant embodiment, the variable time delay entry mode can be selected manually by the shopkeeper, according to the second variation criterion described above (longer time delay for the function keys), for example before the user enters his confidential code (whether or not the user is partially sighted). This is because, as the terminal of the shopkeeper may serve for several uses (for example in the case where the terminal is the smartphone of the shopkeeper), the shopkeeper may select the operating mode according to the use made of the terminal: functioning in variable time delay entry mode when the terminal is used to perform a payment operation, and “conventional” functioning in the other uses of a smartphone.

According to a second variant embodiment, still in the case where the electronic terminal is an electronic payment terminal of a shopkeeper, it is the reading, by the electronic terminal, of predetermined information relating to a user of the electronic payment terminal that automatically selects the operating mode of the terminal.

For example, the predetermined information belongs to the group comprising:
predetermined information on a memory card of said at least one user of said electronic terminal;
predetermined information present on a distant server and relating to a memory card of said at least one user of said electronic terminal.

Thus, according to a first example embodiment, it is the reading of predetermined information of a card of the user (for example a payment card inserted in the payment terminal, or a payment card the magnetic strip of which is read by the payment terminal) that automatically selects the operating mode of the terminal. For example, a partially sighted user may have a preconfigured card for selecting the variable time delay entry mode, whereas a non-preconfigured card of a user who is not partially sighted has no effect on the operating mode of the terminal (which remains in a default “conventional” operating mode, with an identical time delay for all pressings).

According to this particular embodiment, the automatic selection comprises the following substeps:
a step of inserting the memory card;
a step of reading at least one data item on the memory card;
a step of detecting, from the data on the memory card, at least one predetermined item of authentication information intended to select the variable time delay entry mode.

Thus, in the case where the insertion of a card makes it possible to automatically select the operating mode of the terminal, it is in fact the reading of the data on the card and more particularly the detection of a predetermined item of authentication information that enables the variable time delay entry mode to be selected.

According to a second example of this second variant, the automatic selection comprises the following substep:
a step of inserting the memory card;
a step of communication between the electronic terminal and the distant server;
a step of reading at least one data item, on the distant server, relating to the memory card and/or to the user, the data item corresponding to at least one predetermined item of authentication information intended to select the variable time delay entry mode.

Thus it is the reading of predetermined information on a distant server, for example the server of the banking organisation relating to the account of the user who automatically selects the operating mode of the terminal, or an intermediate server intended to store authentication information on users such as being partially sighted. To do this, when the user inserts his card in the electronic payment terminal, a communication is implemented between the electronic payment terminal and the distant server, so as to obtain, if such exists, information authenticating the user as being a partially sighted person, wishing to benefit from the variable time delay entry mode.

The disclosure also concerns a module for managing the entry of data by pressing on a touch surface of an electronic terminal, using at least time delay means aimed at validating a pressing only if the duration of this pressing exceeds a predetermined threshold, referred to as to pressing validation time delay, and comprising:
means for configuring the pressing validation time delay, delivering a variable pressing validation time delay according to at least one predetermined variation parameter and the rank of the pressing in a series of several pressings;
means for managing a plurality of pressings on the touch surface of the electronic terminal, taking account of the variable pressing validation time delay configured.

The management module is in particular able to implement the steps of the management method described above, according to its various embodiments.

The disclosure also concerns an electronic terminal having a touch surface and a module for managing the entry of data by pressing on the touch surface as described previously.

The disclosure also concerns a computer program downloadable from a communication network and/or stored on a medium that can be read by computer and/or executed by a processor, comprising program code instructions for executing the method as described above, according to its various embodiments, when it is executed by a processor.

The disclosure also concerns a storage medium that can be read by computer and is non-transient, storing a computer program comprising a set of instructions that can be executed by a computer or a processor for implementing the method as described above, according to its various embodiments.

### LIST OF FIGURES

Other features and advantages will emerge more clearly from a reading of the following description of a particular embodiment, given by way of simple illustrative and non-limitative example, and the accompanying drawings, among which:

FIG. 1 presents the main steps of the management method according to a particular embodiment of the disclosure;

FIGS. 2a and 2b show two example embodiments of the disclosure;

FIG. 3 shows a simplified example of a management module according to an embodiment of the disclosure.

### DETAILED DESCRIPTION OF ILLUSTRATIVE EMBODIMENTS

General Principle

The general principle of an illustrative embodiment consists of providing a technique for adapting the method of managing the entry of data by a touch screen of an electronic terminal to a particular use such as use by a partially sighted person for example, while also allowing optimum functioning by a user who is not partially sighted.

The disclosure, according to one or more various embodiments, applies more particularly to electronic payment terminals having a virtual keypad displayed on a touch screen enabling data to be entered by a user.

The general principle of an exemplary embodiment is based on the use of a pressing validation time delay, that is to say a time delay making it possible to validate the pressing as a data entry, variable according to the usual pressing, the variability of the time delay depending on at least one predetermined variation parameter.

For example, this variation parameter makes it possible to use a pressing validation time delay that is longer for the first pressing in a series of pressings (for example the first digit of a PIN code) or a longer time delay for a pressing on a predetermined specific region of the touch screen.

In addition, this use of a variable time delay may be triggered by a selection, manual or automatic, of a specific operating mode of the electronic payment terminal.

### Description of One Embodiment

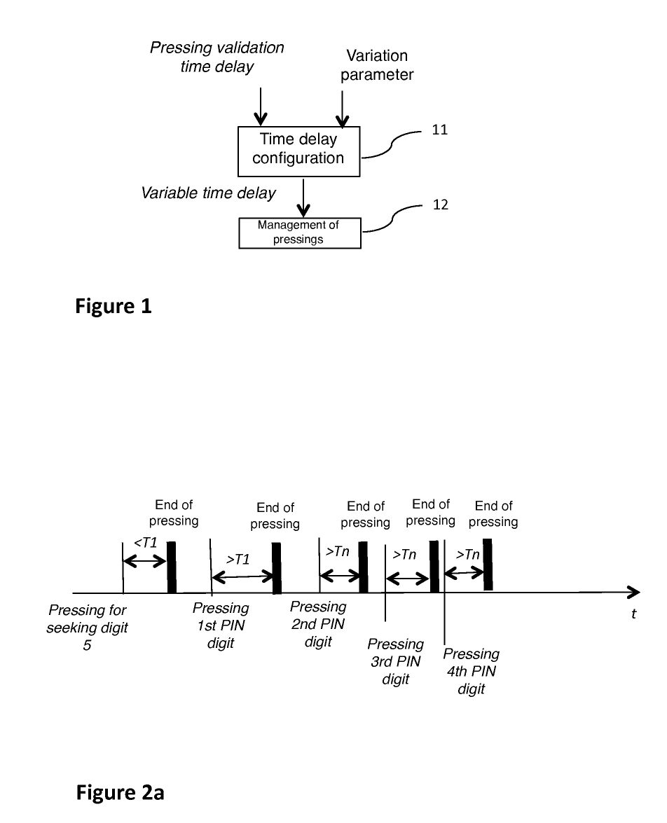

The main steps of the method for managing the entry of data by pressing on a touch surface is now presented in relation to FIG. 1, according to a particular embodiment.

According to this embodiment, a first step 11 of configuring the pressing validation time delay, conventionally of a constant value whatever the pressing on the touch screen, takes into account a predetermined variation parameter, for delivering a variable time delay.

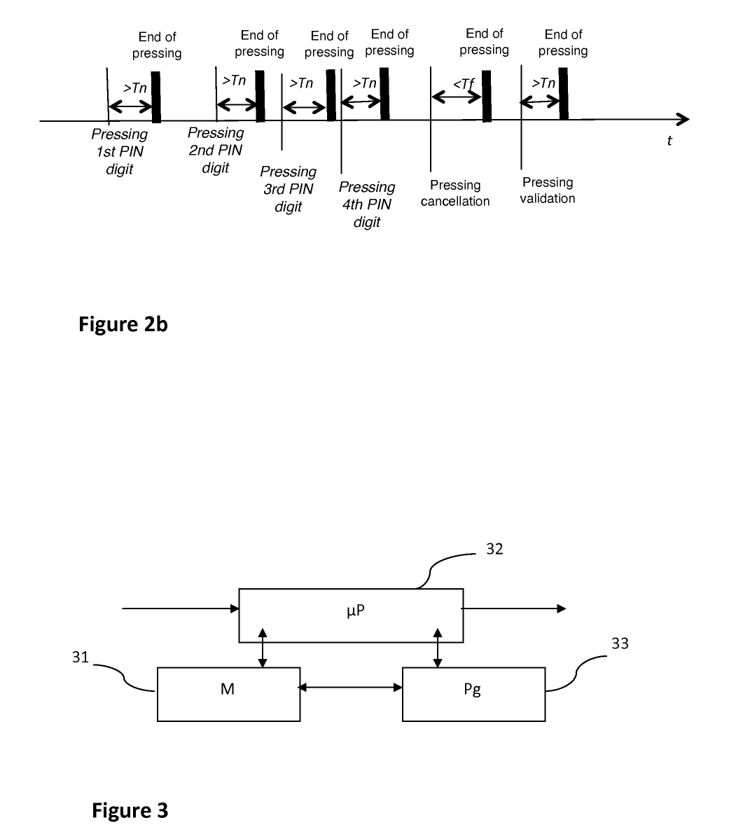

According to different variant embodiments illustrated for example in FIGS. 2a and 2b and described in more detail below, the variation parameter may configure a time delay value that is longer for the first pressing in a series of several pressing (FIG. 2a), or a longer time delay value for a pressing on a predetermined specific region of the touch screen (FIG. 2b).

A step 12 of management proper of the pressings performed by a user on the touch screen of the electronic terminal is then performed, taking account of the variable time delay configured during step 11.

Thus the method of managing the entry of data by pressing on the touch screen of an electronic terminal is modified so as to adapt to a particular use designed for this electronic terminal.

Moreover, the use of the method, and more particularly the step of configuring the time delay, is triggered by the selection, manual or automatic, of a specific operating mode of the electronic terminal.

Thus, according to a first variant embodiment, a user of the electronic terminal selects, manually, for example by validating a choice displayed by the terminal or entering specific data (a particular series of digits or keys) on the terminal, a specific operating mode, different from the conventional operating mode, for the terminal.

According to a second variant embodiment, the selection of a specific operating mode of the terminal is made automatically, for example by reading a predetermined data item on a memory card of a user of the terminal, for example the preconfigured payment card of a partially sighted user, or a data item stored on a distant server and relating to the preconfigured payment card of a partially sighted user.

Various examples of a specific operating mode of the terminal are described below.

### Description of a First Example Embodiment

A first particular example embodiment of the disclosure, illustrated in FIG. 2a, makes it possible to adapt the functioning of an electronic payment terminal having a touch screen for optimum use both by a partially sighted user and by a user who is not partially sighted.

According to this example embodiment, the electronic payment terminal has, according to the prior art, a virtual keypad displayed on a touch screen, the surface of which has a relief making it possible to locate the digit 5, for example a hollow or projecting point. This feature enables a partially sighted user to locate himself on the touch screen, by identifying the position of the digit 5 and, by deduction, the position of the other digits. In this way, a partially sighted user may for example enter his confidential code, as well as validate it, in complete security since it is without assistance from a third party.

As already indicated previously, the main drawback of such a terminal of the prior art lies in the fact that the digit 5 may be considered to be a data entry, for example as the first digit of a confidential code, when the partially sighted user moves his finger over the screen seeking the relief marking this digit 5. This is because during the time that the user locates the relief he leaves his finger on the screen for a period that may be sufficient for a data item to be considered to be entered. This “false” entry may then give rise to an error in the entry of the confidential code and greatly penalise the user.

According to this embodiment, provision is therefore made for a variable pressing validation time delay to be configured, according to a predetermined variation parameter.

In this example, this parameter consists of providing a greater time delay length, denoted T1, for the first pressing in a series of several pressings, thus making it possible to avoid a false entry of the digit 5, when the user seeks to detect this digit. This time delay T1 may for example be one second, whereas the validation time delay for the following pressings, denoted Tn, may be 0.4 seconds.

This is because, in concrete terms, it is considered that the user does not leave his finger for more than one second on the digit 5, when he is seeking the relief for locating it. On the other hand, by intentionally leaving his finger for more than one second on the first digit of the confidential code that he enters, the pressing corresponding to the first digit is therefore greater than the time delay T1 and the entry of the first digit is therefore validated. The user can then leave his finger for a shorter time, while exceeding the time delay Tn of 0.4 seconds for the following pressings, corresponding to the following digits of his confidential code to be validated. For example, an audible signal confirming validation of a pressing can be emitted when the corresponding time delay is exceeded, thus enabling a partially sighted user to be assured that a digit has been entered in order to pass to the entry of the following digit of his confidential code.

The method according to this example embodiment of the disclosure therefore enables a partially sighted user to use an electronic payment terminal with a virtual keypad and a touch screen in an optimum and secure manner.

In addition, this example also makes it possible not to penalise a user who is not partially sighted by not slowing down all the entries of the confidential code, but only the entry of the first digit, unlike the techniques of the prior art, which provided for a longer time delay for all the entries.

According to a first variant embodiment of this example, the electronic payment terminal provides that a specific mode, denoted a variable time delay entry mode, may be selected manually, by a user of the terminal, the shopkeeper or the customer for example.

In this case, a message may be displayed on the terminal, before the start of the transaction or payment operation, for the choice of the operating mode, “conventional” or with variable time delay. For example, if the customer indicates to the shopkeeper that he is partially sighted, the shopkeeper may respond to the message displayed by validating the variable time delay entry mode before leaving the customer to use the electronic payment terminal for conducting the payment operation.

The shopkeeper can also enter a predetermined code, or a predetermined combination of keys, if the customer indicates to him that he is partially sighted and that he wishes to benefit from the variable time delay entry mode.

The configuration of the time delay is then implemented, according to the various embodiments described above.

Provision is made, in a particular embodiment, for the duration of the time delay for the first pressing to be configurable by the user, for example in order to take account of the fact that the user is partially sighted or non-sighted (in this case it may be useful to provide a longer time delay for the first pressing).

Moreover, once the transaction has been made in variable time delay entry mode, the terminal can return automatically to a default “conventional” operating mode, or the operating mode, “conventional” or variable time delay entry, must be selected manually at the start of each new payment operation.

According to a second variant embodiment of this example, the specific operating mode of the terminal (the variable time delay entry mode) may be selected automatically, via the reading of a specific data item of a preconfigured memory card of a user of the terminal, the shopkeeper or the customer for example, or the reading of a specific data item of a distant server, relating to the memory card of a user of the terminal, or relating to the bank card of this user. This distant server is for example the server of the banking organisation of the account of the user, or an intermediate server intended to store authentication information of users as being partially sighted.

Thus, when a partially sighted customer provided with a preconfigured card to enable a specific operating mode to be selected inserts his card in the electronic payment terminal (or passes his card through a magnetic strip reader or in front of a contactless reader), the card reader detects, among the data on the card, authentication information authenticating the user as being partially sighted and wishing to benefit from the variable time delay entry mode. For example, the payment card of the user is preconfigured with a special key that enables him to be authenticated with the terminal in order to prove to it that the bearer of the card is partially sighted.

The terminal therefore automatically detects a request to change operating mode and then implements the steps of the method according to the various embodiments described above.

Moreover, once the transaction has been made in variable time delay entry mode, the terminal automatically returns to a default “conventional” operating mode.

### Description of a Second Example Embodiment

A second particular example embodiment of the disclosure illustrated in FIG. 2b makes it possible to adapt the functioning of an electronic communication terminal (for example a smartphone, tablet, etc.) having a touch screen and able to implement payment operations, for all the circumstances of use of this terminal.

Thus for example a shopkeeper is considered who uses his smartphone for the payment operations of his customers, in addition to the conventional communication functionalities of a smartphone.

The shopkeeper may wish to facilitate the use of a smartphone for his customers, in particular a customer who would not have frequent usage of a touch screen for entering his confidential code for example. In this case, it is possible for such a user to be confronted frequently with undesired entries of certain keys, for example by leaving his finger too long on the screen after an entry, or by not being sufficiently precise when he places his finger on the screen for an entry of a digit or a function key.

In particular, it is preferable that the function keys for correcting or cancelling previous entries corresponding to the digits of a confidential code are not validated by error.

To do this, provision is therefore made for a variable pressing validation time delay to be configured, according to a predetermined variation parameter consisting of providing a longer validation time delay, denoted Tf, according to the region of pressing on the screen, and more particularly when the pressing region corresponds to a function key such as the correction or cancellation of the previous entries.

Thus, according to this example, when a user wishes to correct or cancel one or more previous entries, he must intentionally leave his finger on the key in question for a period greater than the time delay Tf, for example of one second, while a time delay Tn, provided for the other pressings, is 0.4 seconds for example.

The method according to this example embodiment of the disclosure therefore enables a user to avoid entry errors requiring his code to be entered once again, by extending the validation time delay for a pressing corresponding to certain function keys such as correction or cancellation.

In addition, this example makes it possible not to penalise the entry of the confidential code by not slowing down this entry because the time delay for pressings corresponding to digits remains short while preventing a “clumsy” user from cancelling the entry of his code by an undesired pressing on the cancellation function key for example.

### Description of a Simplified Example of a Management Module

FIG. 3 illustrates a simplified architecture of a module for managing the entry of data by pressing on a touch surface of an electronic terminal, comprising a memory 31 consisting of a buffer, a processing unit 32, equipped for example with a microprocessor, and controlled by the computer program 33, implementing a method for managing the entry of data by pressing on a touch surface of an electronic terminal according to one or more of the various embodiments of the disclosure.

On initialisation, that is to say when the electronic terminal in which the management module is integrated is powered up, the computer program code instructions 33 are for example loaded into a memory before being executed by the processor of the processing unit 32.

Next, for example at the start of a payment operation, the processing unit 32 receives as an input at least one variation parameter for the configuration of the pressing validation time delay. The microprocessor of the processing unit 32 implements the step of the management method, in accordance with the instructions of the computer program 33 for configuring the variable pressing validation time delay and managing the pressings on the touch screen of the electronic terminal.

For this purpose, the management module comprises, apart from the buffer 31, means for configuring the pressing validation time delay, delivering a variable pressing validation time delay according to at least one predetermined variation parameter and means for managing a plurality of pressings on the touch surface of the electronic terminal taking account of the variable pressing validation time delay configured.

Although the present disclosure has been described with reference to one or more examples, workers skilled in the art will recognize that changes may be made in form and detail without departing from the scope of the disclosure and/or the appended claims.

1. A method for managing entry of data by pressing on a touch surface of an electronic terminal, said method comprising:
configuring a variable pressing validation time delay according to at least one predetermined variation parameter and a rank of the pressing in a series of several pressings;
managing said series of several pressings on said touch surface of said electronic terminal, taking account of said variable pressing validation time delay as configured, wherein managing said series of several pressing comprises validating a pressing on the touch surface only if a duration of this pressing exceeds said variable pressing validation time delay as configured.

2. The method according to claim 1, wherein said predetermined variation parameter belongs to the group consisting of:
a pressing validation time delay that is longer for a
first pressing in the series of several pressings;
a pressing validation timed delay that is longer according to a location of the pressing on a region of said touch screen.

3. The method according to claim 1, wherein said configuring said variable pressing validation time delay is triggered by a selection of a predetermined entry mode, referred to as a variable time delay entry mode, for said electronic terminal.

4. The method according to claim 3, wherein said selection of a variable time delay entry mode belongs to the group consisting of:
manual selection by at least one user of the electronic terminal,
automatic selection by a reading, by said electronic terminal, of at least one predetermined item of information relating to at least one user of said electronic terminal.

5. The method according to claim 4, wherein said selection comprises the automatic selection and said predetermined item of information belongs to the group consisting of:
predetermined information on a memory card of said at least one user of said electronic terminal;
predetermined information present on a distant server and relating to a memory card of said at least one user of said electronic terminal.

6. The method according to claim 4, wherein said selection comprises said automatic selection, which comprises:
inserting said memory card into said electronic terminal;
reading at least one data item on said memory card;
detecting, from said at least one data item on said memory card, at least one predetermined item of authentication information intended to select the variable time delay entry mode.

7. The method according to claim 4, wherein said selection comprises said automatic selection, which comprises:
inserting said memory card into said electronic terminal;
communicating between said electronic terminal and said distant server;
reading at least one data item, on said distant server, relating to at least one of said memory card or to said user, said data item corresponding to at least one predetermined item of authentication information configured to select the variable time delay entry mode.

8. A module for managing the entry of data by pressing on a touch surface of an electronic terminal, said module comprising:
means for configuring a variable pressing validation time delay according to at least one predetermined variation parameter and a rank of the pressing in a series of several pressings;
means for managing said series of several pressings on said touch surface of the electronic terminal, taking account of said variable pressing validation time delay as configured, wherein managing said series of several pressing comprises validating a pressing on the touch surface only if a duration of this pressing exceeds said variable pressing validation time delay as configured.

9. The module of claim 8, wherein the module is implemented within the electronic terminal.

10. (canceled)

11. A non-transitory computer-readable storage medium comprising a computer program stored thereon and comprising a set of instructions, which when executed by a computer or a processor implement a method for managing entry of data by pressing on a touch surface of an electronic terminal, said method comprising:
configuring a variable pressing validation time delay according to at least one predetermined variation parameter and a rank of the pressing in a series of several pressings;
managing said series of several pressings on said touch surface of said electronic terminal, taking account of said variable pressing validation time delay as configured, wherein managing said series of several pressing comprises validating a pressing on the touch surface only if a duration of this pressing exceeds said variable pressing validation time delay as configured.
